(19) United States
(12) Patent Application Publication
(10) Pub. No.: US 2005/0173996 A1
(43) Pub. Date: Aug. 11, 2005

(54) Perpetual motion energy

(76) Inventor: Abram Amold Ellison, Detroit, MI (US)

Correspondence Address: Abram Ellison, 19925 Lauder, Detroit, MI, 48235, US

(21) Appl. No.: 10/772,346

(22) Filed: Feb. 6, 2004

(51) Int. Cl. H02K 1/00

(52) U.S. Cl. 310/40 R; 74/DIG. 9

(57) ABSTRACT

Perpetual motion energy can be used to replace oil, gas, and coal as major sources of energy, by replacing them with perpetual motion energy. One of the many uses for perpetual motion energy is illustrated in a electrical circuit for electric for electric cars or vehicles, showing how: two or more batteries transmit electric current and amps. to a Electric Wire Distributor Connector; the distributor sends electric current and amps. to a electric motor; the electric motor provides power, and also rotates a generator; the generator charges two or more batteries; the distributor also recharges the batteries by recycling one hundred percent or more energy back to the batteries to produce perpetual motion energy. The batteries do not have to be recharged by any other source. Furthermore, the same circuitry can be applied to in-house electric generators to supply electricity and heat energy to residential, and commercial buildings. The use of perpetual motion energy can provide perpetual, efficient, reliable, clean and economical energy through the use of batteries as a power source.

### CROSS-REFERENCE TO RELATED APPLICATION

The present application is based on:
U.S. Pat. No 6,664,475 B1, issued on Dec. 16, 2003.
Primary Examiner—Chau N. Nguyen
application Ser. No. 10/337,839, filed on Jan. 8, 2003.
Provisional application No. 60/345610, filed on Jan. 4, 2002

### BACKGROUND OF THE INVENTION

The intention of the present invention is to replace oil, gas, and coal as major sources of energy, by replacing them with perpetual motion energy. Furthermore it is the intention of the present invention is to provide perpetual, efficient, reliable, clean and economical energy through the use of batteries. Furthermore, and more particularly, the present invention relates to a circuit for electric cars or vehicles, showing how: two or more batteries transmit electric current and amps. to a Electric Wire Distributor Connector; the distributor sends electric current and amps. to a electric motor; the electric motor provides power, and also rotates a generator; the generator charges two or more batteries; the distributor also recharges the batteries by recycling one hundred percent or more energy back to the batteries to produce perpetual motion energy. The batteries do not have to be recharged by any other source.

Furthermore, the same circuitry can be applied to in-house electric generators to supply electricity and heat energy to residential, and commercial buildings.

### DESCRIPTION OF THE PRIOR ART

It is a feature of the invention to provide an electric wire distributor connector for receiving and distributing electric current through electric wires, with the connector comprising a connector housing, and a distributor comprising a distributor housing. The connector housing and distributor housing are connected together and made from a non-conductive material. The electric wire distributor connector housing comprise a detachable top and bottom cover placed one on top of the other.

Another feature of the invention is to provide an electric wire distributor connector of the aforementioned type wherein the connector housing and cover define an inlet therebetween for respectively receiving electric wires, a terminal assembly comprising a plurality of mounting blocks attached to the connector base and a plurality of metallic conductors operatively attached to the mounting blocks, one metallic conductor for each mounting block.

Still another feature of the invention is to provide an electric wire distributor connector of the aforementioned type wherein a plurality of metallic extension rods are provided, each having a pair of ends, one extension rod for each of the metallic conductors, with one end of each extension rod being attached to a corresponding metallic conductor; and a plurality of spaced apart metallic distributors placeably one above the other with the other end of the extension rod attached to a corresponding distributor to transfer current from the metallic conductors to the distributors and vice versa connector of the aforementioned type wherein exposed ends of the electric wires are placed between the U-shaped members and the tops of the metallic conductors and thereafter the threaded fasteners are tightened to releasable attach the wires to the metallic conductors.

Another further feature of the invention is to provide an electric wire distributor connector of the aforementioned type wherein the threaded fasteners of the terminal assembly form the clamping members, with the exposed ends of the wires wrapped around the threaded fasteners and the threaded fasteners are then tightened to clamp the ends of the wires against the metallic conductors.

A still further feature of the invention is to provide an electric wire distributor connector of the aforementioned type wherein annular sealing members can be located in groves formed between the conductor housing and the cover where cables containing the electric wires pass through the inlet to resist any flow of water into the connector and distributor housings.

Another further feature of the invention is to provide an electric wire distributor connector of the aforementioned type wherein the distributor housing can have a circumferentially extending wall projecting upwardly from said distributor housing, an opening provided in said wall, with said connector housing received in said opening and secured to said distributor housing.

A final feature of the present invention is to provide an electric wire distributor connector of the aforementioned type wherein there can be one or more connector housings.

### BRIEF SUMMARY OF THE INVENTION

A feature of the present invention is one or more batteries transmit electric current, and amps. to a, Electric Wire Distributor Connector.

Another feature of the present invention is a distributor transmits electric current to a electric motor.

Still a further feature of the present invention is a electric motor provides power, and also rotates generator.

A further feature of the present invention is a generator charges one or more batteries.

Still another feature of the present invention is a Electric Wire Distributor Connector recharges the batteries by recycling one hundred percent or more energy back to the batteries to produce perpetual motion energy.

A further feature of the present is a regulator to regulate the flow of electric current where necessary.

Still another feature of the present invention is electric cars or vehicles can run on perpetual motion.

A further feature of the present invention is a generate can provide electricity and heat energy for residential and commercial buildings.

### BRIEF DESCRIPTION OF THE DRAWINGS

FIG. 1 Is the perspective view of the electric circuitry for perpetual motion energy.

### DETAILED DESCRIPTION OF THE PREFERRED EMBODIMENT

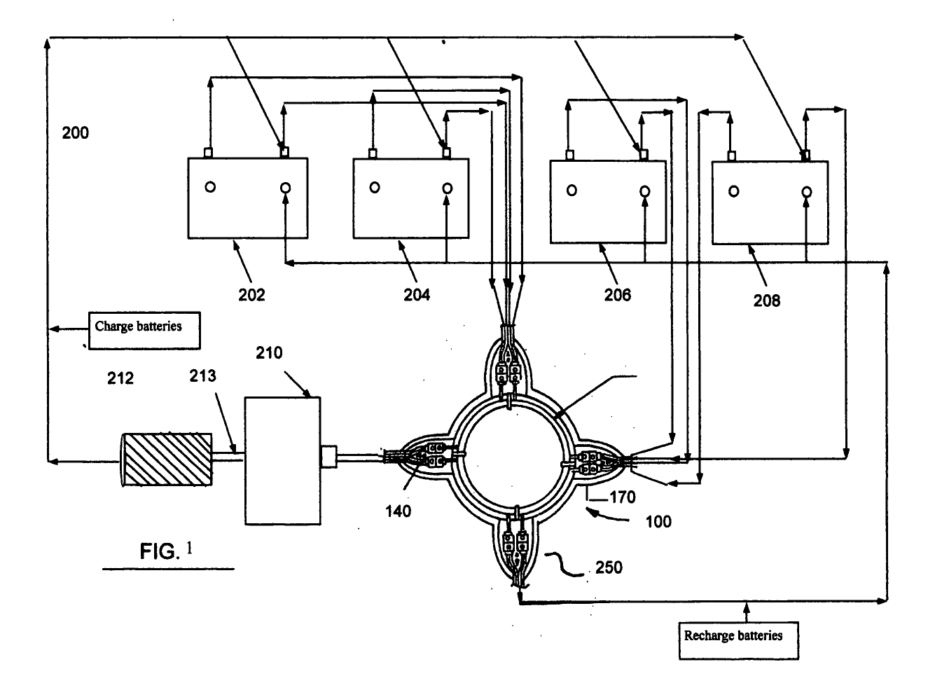

One of the many uses for the electric wire distributor connector is illustrated in the electrical circuit 200 of FIG. 1 where four batteries 202, 204, 206, 208 are illustrated. These batteries, as an example, may be the batteries used to provide power to run an electric car or vehicle. The current or voltage, and amperes from batteries 202 and 204 is directed to the electric wire distributor connector 100 at terminal assembly 150. Batteries 206 and 208 are directed to terminal assembly 170. One of the terminal assemblies 140 of distributor 100 is connected to and drives a battery driven motor 210 which is in turn connected to and drives a generator 212 by a shaft 213. The generator 212 directs the current or voltage, and amperes to the batteries 202-208 inclusive to recharge the batteries. Terminal assembly 250 distributes electric current or recycle electric current or voltage and, amperes back to batteries 202-208. Terminal assembly 250 can also generate electric current or voltage the same as previously mentioned above at 140, 210, 212, 213 to recharge the batteries 202-208 inclusive. The procedures can be repeated as many times as necessary at added terminal assemblies to run the electric car continuously without the batteries being recharge from any outside source, which is perpetual motion. The above described circuitry can also be used to run a in-house generator system to provide electric, and heat energy to residential and commercial buildings. The generator can also be run by a v belt from a electric motor.

A regulator, preferably electronically controlled, can be used to control the flow of electric current or voltage, and amperes. The controlling device could be installed inside the top cover of the distributor.

Although, the present invention has been described herein with respect to the preferred embodiment thereof, the forgoing description is intended to be illustrative, and not restrictive. Those persons skilled in the art will realize that many modifications of the preferred embodiment could be made which would be operable. For example electric motion energy can be used in many commercial applications, and other types of transportation. For example we may some day explore outer space on airships propelled by perpetual motion power.

1. A perpetual motion energy circuit for providing continuous or perpetual motion energy comprising:

2. Two or more electric batteries for providing electric current to a, Electric Wire Distributor Connector.

3. A Electric Wire Distributor Connector, for transmitting electric current and amperes to a electric motor.

4. A electric motor for providing power, and rotating a electric generator.

5. A generator for transmitting electric current to two or more batteries to charge said batteries.

6. A above said, Electric Wire Distributor Connector, for recycling one hundred percent or more energy back to above said batteries to recharge said batteries, which is perpetual motion energy.

7. Above said batteries do not have to be recharged by any other source.

8. Above said circuitry for powering electric cars or vehicles.

9. Above circuitry for providing electricity, and heat energy for residential and commercial buildings.

10. Above said circuitry for producing perpetual motion energy.
